(19) United States
(12) Patent Application Publication
(10) Pub. No.: US 2023/0059231 A1
(43) Pub. Date: Feb. 23, 2023

(54) WATER-REPELLENT COAT AND PRODUCT HAVING WATER-REPELLENT COAT FORMED THEREON, AND METHOD OF REPAIRING WATER-REPELLENT COAT

(71) Applicant: Mitsubishi Electric Corporation, Tokyo (JP)

(72) Inventors: Yasuhiro YOSHIDA, Tokyo (JP); Natsumi KUBOTA, Tokyo (JP)

(73) Assignee: Mitsubishi Electric Corporation, Tokyo (JP)

(21) Appl. No.: 17/789,806

(22) PCT Filed: Mar. 11, 2020
(86) PCT No.: PCT/JP2020/010450

§ 371 Date: Jun. 29, 2022

(51) Int. Cl. C09D 127/12; B05D 7/00; C09D 175/04; B05D 5/00; C09D 7/61; C09D 7/40; C09D 7/65; C09D 183/06

(52) U.S. Cl. CPC C09D 127/12; B05D 7/52; C09D 175/04; B05D 5/005; C09D 7/61; C09D 7/67; C09D 7/65; C09D 183/06; B05D 2201/02

(57) ABSTRACT

A water-repellent coat according to the present disclosure includes: an undercoat layer that is formed on a surface of a base material and contains a base resin, at least one kind of spherical particles, and water-repellent particles, the at least one kind of spherical particles having an average particle diameter of 2 μm or more and 1000 μm or less and being selected from the group consisting of spherical molten silica particles, spherical molten alumina particles, and spherical silicone resin particles, the water-repellent particles having an average particle diameter of 5 nm or more and 30 nm or less; and a topcoat layer formed on the undercoat layer and containing a water-repellent resin and the water-repellent particles contained in the undercoat layer.

### TECHNICAL FIELD

The present disclosure relates to a water-repellent coat and a product having the water-repellent coat formed thereon, a method of repairing the water-repellent coat, and a method of detecting deterioration of the water-repellent coat.

### BACKGROUND ART

As a method of forming a water-repellent surface for preventing or reducing adhesion of water, snow, or other materials to a base material surface of an article, for example, the following methods are proposed: a method of mechanically processing or etching the base material surface; and a method of coating the base material surface with a coating composition containing particulates or a particulate precursor and a resin.

Of these methods, the method using a coating composition is advantageous in terms of productivity and production costs, because water repellency can be given to base materials having various shapes simply by applying a resin solution to the base materials. In this case, however, since the above advantage is obtained when a water-repellent substance in the coating composition forms fine irregularities at a surface of the water-repellent coat, the water-repellent coat easily deteriorates due to wear. To handle wear of a water-repellent coat, a water-repellent coat formed of, for example, a coating composition including fluororesin particles, a binder component, and an organic solvent and further including silicon dioxide particles having a particle diameter of 2 to 5 microns is proposed. After the water-repellent coat is worn, the water repellency is recovered by re-applying the coating composition without increasing the thickness of the coat (see Patent Literature 1).

### CITATION LIST

### Patent Literature

Patent Literature 1: Japanese Unexamined Patent Application Publication No. 2002-348566

### SUMMARY OF INVENTION

### Technical Problem

However, to begin with, the water-repellent coat disclosed in Patent Literature 1 easily deteriorates due to wear, since the water-repellent coat is formed of the particles and the binder component. In the recovery of water repellency by re-application of the coating composition, an existing water-repellent coat is peeled to reduce an increase in the thickness of the coat. The water-repellent coat obtained after the re-application is, however, not uniform and has low strength, and the initial water repellency cannot be recovered.

The present disclosure is applied to solve the above problem, and relates to a water-repellent coat whose water repellency is not easily deteriorated even when a surface of the coat is worn by friction or other stimuli, and a product having the water-repellent coat formed thereon, a method of repairing a water-repellent coat such that the initial water repellency thereof can be recovered by a simple process even when the water repellency is deteriorated, and a method of detecting deterioration of the water-repellent coat.

### Solution to Problem

The present disclosure relates to a water-repellent coat that includes: an undercoat layer formed on a surface of a base material and containing a base resin, at least one kind of spherical particles, and water-repellent particles, the at least one kind of spherical particles having an average particle diameter of 2 μm or more and 1000 μm or less and being selected from the group consisting of spherical molten silica particles, spherical molten alumina particles, and spherical silicone resin particles, the water-repellent particles having an average particle diameter of 5 nm or more and 30 nm or less; and a topcoat layer formed on the undercoat layer and containing a water-repellent resin and the water-repellent particles contained in the undercoat layer. It also relates to a water-repellent coat repairing method of repairing a deteriorated water-repellent coat by applying to the water-repellent coat, a repair liquid containing a solvent that dissolves the water-repellent resin but does not dissolve the base resin.

### Advantageous Effects of Invention

It is possible to provide a water-repellent coat whose water repellency is not easily deteriorated even when a surface of the coat is worn by friction or other stimuli, and a method of repairing the coat such that the initial water repellency can be recovered by a simple process even when the water repellency is deteriorated, and a method of detecting deterioration of the coat.

### BRIEF DESCRIPTION OF DRAWINGS

FIG. 1 is a schematic sectional view of a water-repellent coat according to Embodiment 1 of the present disclosure.

FIG. 2 is a schematic sectional view of a water-repellent coat according to Embodiment 2 of the present disclosure.

FIG. 3 is a schematic sectional view of a deteriorated water-repellent coat according to Embodiment 3 of the present disclosure.

FIG. 4 is a schematic sectional view of a repaired water-repellent coat according to Embodiment 3 of the present disclosure.

FIG. 5 is a schematic sectional view of a radome having a water-repellent coat according to Embodiment 5 of the present disclosure.

FIG. 6 is a schematic sectional view of an outdoor unit in an air-conditioning apparatus, to which the water-repellent coat according to Embodiment 5 of the present disclosure is applied.

### DESCRIPTION OF EMBODIMENTS

### Embodiment 1

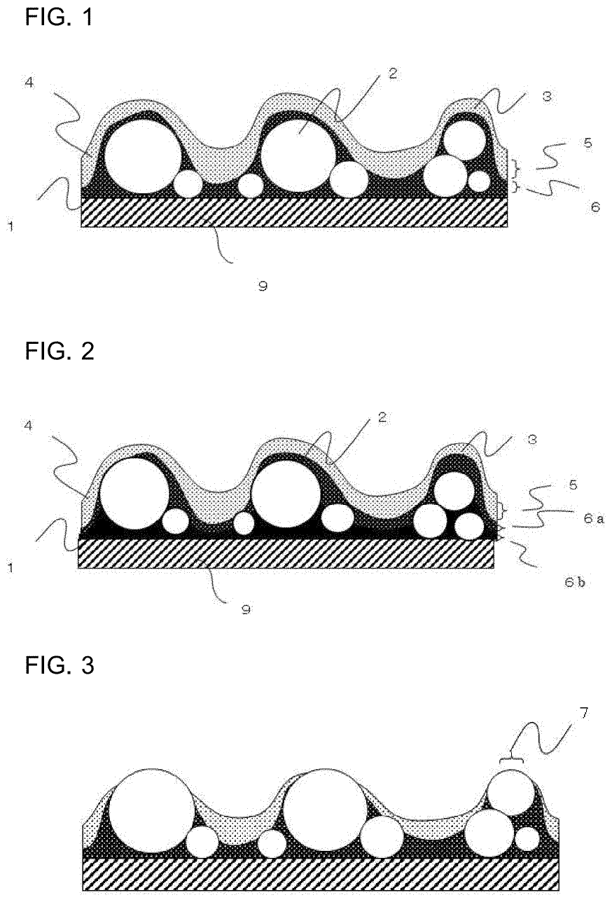

FIG. 1 is a schematic sectional view of a water-repellent coat according to Embodiment 1 of the present disclosure.

As illustrated in FIG. 1, the water-repellent coating film according to Embodiment 1 includes an undercoat layer 6 and a topcoat layer 5. The undercoat layer 6 is formed on a surface of a base material 9, and contains: at least one kind of spherical particles 2 that have an average particle diameter of 2 μm or more and 1000 μm or less and are selected from the group consisting of spherical molten silica particles, spherical molten alumina particles, and spherical silicone resin particles; water-repellent particles 3 having an average particle diameter of 5 nm or more and 30 nm or less; and a base resin 1. The topcoat layer 5 is formed on the undercoat layer 6, and contains water-repellent particles 3 having an average particle diameter of 5 nm or more and 30 nm or less and a water-repellent resin 4. The undercoat layer 6 contains at least one kind of spherical particles 2 having an average particle diameter of 2 μm or more and 1000 μm or less and selected from the group consisting of spherical molten silica particles, spherical molten alumina particles, and spherical silicone resin particles, and a surface of the undercoat layer 6 has irregularities. The topcoat layer 5 is formed on the undercoat layer 6 having irregularities, thereby reducing the probability that the water-repellent coating film itself will be damaged by wear or be peeled. Furthermore, the undercoat layer 6 contains water-repellent particles 3 having an average particle diameter of 5 nm or more and 30 nm or less that are included also in the topcoat layer 5. By virtue of this structure, the adhesion between the undercoat layer 6 and the topcoat layer 5 is improved, and the water-repellent coating film is not easily peeled.

When the surface of the water-repellent coat according to Embodiment 1 is rubbed, part of the topcoat layer 5 that is located on protrusions of the undercoat layer 6 wears, but part of the topcoat layer 5 that is located on recesses of the undercoat layer 6 does not easily wear. When rubbing is repeated and the wear thus progresses, the base resin 1 is worn, and the spherical particles 2 are partially exposed, but the wear does not easily further progress. In the vicinity of areas where the spherical particles 2 are exposed, fine water droplets easily adhere, but water repellency is maintained. This is because spherical molten silica particles and spherical molten alumina particles that are the spherical particles 2 have high surface smoothness, high density, and high hardness, and thus have high wear resistance, and spherical silicone particles that are the spherical particles 2 have high surface smoothness and are not easily damaged even when rubbing is repeated. Since spherical silicone particles that are the spherical particles 2 also have high water repellency, the surfaces thereof that are exposed after wear also have water repellency, and their water repellency is easily maintained. Compared with spherical molten silica particles and spherical molten alumina particles, spherical silicone particles that are the spherical particles 2 are easily worn by friction that is produced with hard materials, such as sand and dust; however, the spherical silicone particles are pleasant to the feel when rubbed by hand and have low frictional resistance during rubbing.

The average particle diameter of the spherical particles 2 is 2 μm or more and 1000 μm or less, and preferably, should be 5 μm or more and 100 μm or less. When the average particle diameter is less than 2 μm, the irregularities of the undercoat layer 6 are too small to protect the topcoat layer 5 during rubbing. When the average particle diameter of the particles 2 exceeds 1000 μm, the irregularities of the undercoat layer 6 are too large, as a result of which, for example, foreign materials clog in the recesses of the undercoat layer 6 and the performance of the water-repellent coat is not fulfilled. The average particle diameter of the particles 2 is measured with a laser diffraction particle diameter analyzer.

Preferably, the spherical particles 2 should be spherical molten silica particles and spherical molten alumina particles having surfaces hydrophobized with, for example, a silylating agent or a silane coupling agent. Because of the use of hydrophobized spherical molten silica particles and hydrophobized spherical molten alumina particles, it is possible to improve the water repellency of the surfaces that are exposed when the water-repellent coat is worn, and improve the effect of maintaining the water repellency. The hydrophobization is particularly effective for spherical molten silica particles.

The average particle diameter of primary particles of the water-repellent particles 3 contained in the topcoat layer 5 and the undercoat layer 6 is 5 nm or more and 30 nm or less, and preferably, should be 10 nm or more and 25 nm or less. When the average particle diameter of primary particles of the water-repellent particles 3 contained in the topcoat layer 5 and the undercoat layer 6 is less than 5 nm, it may be difficult for the water-repellent particles 3 to coordinate with resin, and the water-repellent coat may have low water repellency. When the average particle diameter of primary particles of the water-repellent particles 3 contained in the topcoat layer 5 and the undercoat layer 6 exceeds 30 nm, the water-repellent coat may have low water repellency and may lose its water repellency when rubbing is repeated. The average particle diameter of the water-repellent particles 3 is measured with a laser diffraction particle diameter distribution analyzer.

Preferably, as the water-repellent particles 3, hydrophobized inorganic particulates should be used. Although the inorganic particulates are not limited to specific ones, they are, for example, silica, alumina, zirconia, or titania. Since such inorganic particulates generally have hydrophilic surfaces, preferably, the surfaces should be hydrophobized. As the hydrophobizing method, the following methods are present: a method of causing a silylating agent (for example, hexamethyldisilazane), a silane coupling agent, or other agents to react with inorganic particulates; and a method of mixing with inorganic particulates, a silicone compound or fluorocarbon compound that has a lower molecular weight than the water-repellent resin 4 such that the silicone compound or fluorocarbon compound is adsorbed on the surfaces of the inorganic particulates. In the latter method, hydrophobization can be reliably promoted by heating to 100 degrees C. or higher after the above mixing. The former method is preferable because it can obtain highly stable oil repellency. The latter method is advantageous in that inexpensive materials can be used. The inorganic particulates may be hydrophobized while the inorganic particulates are in a powder form, or may be hydrophobized by adding a silylating agent or other agents described above while the inorganic particulates are dispersed in an undercoat layer-forming coating composition. In the latter case, hydrophobization can be reliably promoted by heating the coat by blowing hot air or irradiation of infrared rays after applying the undercoat layer-forming coating composition.

As the base resin 1 used in the undercoat layer 6, various polyolefins, such as polyurethane resin, fluororesin, silicone resin, polypropylene, polyethylene, polyvinyl chloride; and acrylic resin, methacrylic resin, polystyrene, ABS resin, and AS resin can be applied. One of these resins may be applied or two or more of the resins may be applied. Of the resins, polyurethane resin is preferable since it has a high wear resistance, and fluororesin and silicone resin are preferable since it has high water repellency. In order to improve adhesion between the base resin 1 and the base material 9, a resin having, for example, a substituent may be applied.

The undercoat layer 6 can be formed by coating the base material 9 with an undercoat-layer forming coating composition containing a solvent that can form a solution or emulsion from the base resin 1, the spherical particles 2, and the water-repellent particles 3. Preferably, the amount of the spherical particles 2 to the amount of the base resin 1 should be 10 mass % or more and 500 mass % or less, and more preferably should be 30 mass % or more and 200 mass % or less. When the amount of the particles 2 is less than 10 mass % or more, the undercoat layer 6 cannot obtain sufficient irregularities, and may not thus have a high water repellency. When the amount of the particles 2 is more than 500 mass %, there is a possibility that the undercoat layer 6 will not be able to obtain a sufficient strength as the undercoat layer. This is not preferable. Preferably, the amount of the water-repellent particles 3 in the undercoat layer 6 to the amount of the base resin 1 should be 10 mass % or more and 200 mass % or less, and more preferably, should be 20 mass % or more and 100 mass % or less. When the amount of the water-repellent particles 3 is less than 10 mass %, the advantage of improving the adhesion between the undercoat layer 6 and the topcoat layer 5 may not sufficiently be obtained. When the amount of the water-repellent particles 3 exceeds 200 mass %, there is a possibility that the undercoat layer will not be able to have a strength for the undercoat layer.

Preferably, as the solvent contained in the undercoat layer-forming coating composition, a solvent having 3 mass % or more and 40 mass % or less of non-volatile content should be applied. When the non-volatile content is less than 3 mass %, the liquid is so dilute that the particles greatly settle, and is thus not easily used, and the formed coat is too thin to stably fix the particles to the undercoat layer. Thus, it is not preferable. When the non-volatile content exceeds 40 mass %, it is difficult to uniformly form the undercoat layer. Thus, it is not preferable.

Furthermore, a cross-linker may be added to the undercoat layer-forming coating composition in order to improve the strength of the base resin 1. Also, known additives may be added to the undercoat layer-forming coating composition in order to improve the coating properties of the coating composition and the water repellency of the base resin 1.

The undercoat layer-forming coating composition can be applied by, for example, spray coating, brush coating, or roller brush coating. Preferably, the average thickness of the undercoat layer should be 0.5 μm or more and 2000 μm or less. To be more specific, preferably, the average thickness of the undercoat layer should be 1.0 μm or more and 500 μm or less. When the average thickness is less than 0.5 μm, the particles are too sparse and a sufficient resistance to, for example, friction cannot be obtained. When the average thickness exceeds 2000 μm, the coat has excessively large irregularities and thus has poor appearance or has a low strength. It is not preferable. The thickness is calculated from the weight of the coat.

Preferably, the undercoat layer-forming coating composition should be prepared by mixing the water-repellent particles 3, the spherical particles 2, the base resin 1, and the solvent, and then homogenizing the resultant mixture using a submersible disperser, such as a homogenizer, a dissolver, or a high-pressure disperser. Since it is important to appropriately control the dispersion state of the water-repellent particles, a liquid having the water-repellent particles dispersed in the resin is prepared and the particles and the solvent are then added to the liquid, whereby a coating liquid can be prepared more simply and precisely. The water-repellent particles in the coating liquid for the undercoat layer or in the undercoat layer may be dispersed, but preferably should moderately aggregate. This is because the presence of aggregated water-repellent particles having a particle diameter of 1 μm or less can improve the adhesion between the undercoat layer and the topcoat layer without greatly reducing the strength of the undercoat layer.

Regarding the solvent, it suffices that a solvent having a boiling point and a viscosity suitable for the coating method is appropriately selected from solvents that can dissolve the base resin. As such a resin, for example, aromatic, naphthenic, and paraffinic hydrocarbon solvents; alcohols, such as ethanol and 2-propanol; ketones, such as acetone, methyl ethyl ketone, and MIBK; ethers, such as tetrahydrofuran, dimethyl ether, and diethyl ether; and esters, such as ethyl lactate, ethyl acetate, and butyl acetate, can be used.

The topcoat layer 5 can be formed by coating an upper surface of the undercoat layer 6 with a topcoat-layer forming coating composition containing the water-repellent particles 3 having an average particle diameter of 5 nm or more and 30 nm or less, the water-repellent resin 4, and a solvent that can dissolve the water-repellent resin 4. The water-repellent particles 3 are the same as those used in the undercoat layer.

Preferably, the water-repellent resin 4 should be a fluororesin or a silicone resin. The water-repellent resin 4 may be a mixture of a fluorine-based or silicone-based water-repellent additive with a polyurethane resin, an acrylic resin, a methacrylic resin, polystyrene, or other resins.

Preferably, the mixing ratio of the water-repellent particles 3 of the topcoat layer to the water-repellent resin 4 should be 20 mass % or more and 500 mass % or less, and more preferably, should be 50 mass % or more and 200 mass % or less. When the mixing ratio of the water-repellent particles 3 is less than 20 mass %, a sufficient water repellency may not be obtainable. When the mixing ratio of the water-repellent particles 3 exceeds 500 mass %, the water-repellent coat may be brittle, and the topcoat layer may be easily peeled.

Preferably, the total amount of the water-repellent particles 3 and the water-repellent resin 4 used in the topcoat-layer forming coating composition should be 1 mass % or more and 40 mass % or less of the amount of the topcoat-layer forming coating composition, and more preferably, should be 2 mass % or more and 15 mass % or less relative to the topcoat-layer forming coating composition. When the total amount is less than 1 mass %, it is necessary to apply a large amount of coating liquid to obtain a sufficient water repellency, and it may be hard to perform a practical coating due to the large amount. When the ratio of the total amount exceeds 40 mass %, a formed water-repellent film is coarse and thus easily deteriorates.

The solvent used in the topcoat-layer forming coating composition needs to dissolve the water-repellent resin 4 and not to dissolve the base resin 1. When a solvent that dissolves the base resin 1 is used, the base resin or the components of the base resin are eluted and mixed with the formed topcoat layer during application and drying of the topcoat-layer forming coating composition. Consequently, the topcoat layer fails to have a sufficient water repellency. In addition, the undercoat layer may be peeled or may have a lower strength. It suffices that a solvent having a boiling point and a viscosity suitable for the coating method is appropriately selected from solvents having such a dissolution capacity as described above. As such a resin, the following are preferable: various fluorinated solvents; ether-based solvents, such as dimethyl ether and diethyl ether; and ketone-based solvents, such as acetone, methyl ethyl ketone, and methyl isobutyl ketone. These solvents have low polarity, and easily dissolve the water-repellent resin, and do not easily dissolve the base resin. As described later, when being used as a repair agent, these solvents are dried for a short time period and have less odor in many cases. Fluorine solvents have low flammability, and is also preferable in this regard.

Furthermore, a small amount of a solvent that dissolves the base resin of the undercoat layer is mixed with the topcoat-layer forming coating composition, thereby improving the adhesion between the undercoat layer and the topcoat layer. Preferably, the amount of the solvent that dissolves the base resin of the undercoat layer should be 1 mass % or more and 30 mass % or less of the total amount of solvents contained in the topcoat-layer forming coating composition, and more preferably should be 4 mass % or more and 20 mass % or less of the total amount of solvents contained in the topcoat-layer forming coating composition. The adhesion between the undercoat layer and the topcoat layer is not improved. When the amount of the solvent exceeds 30 mass %, the undercoat layer may be peeled or deformed. Thus, this is not preferable.

Preferably, the topcoat-layer forming coating composition should be prepared by mixing the water-repellent particles 3, the water-repellent resin 4, and the solvent, and then homogenizing the resultant mixture using a submersible disperser, such as a homogenizer, a dissolver, or a high-pressure disperser. Since it is important to appropriately adjust the dispersion state of the water-repellent particles, a liquid in which water-repellent particles are dispersed in the resin is prepared and the particles and the solvent are then added to the liquid, whereby a coating liquid can be prepared more simply and precisely. From the standpoint of the dispersion of the water-repellent particles, it is also preferable that a dispersant, such as a surfactant, be added.

Coating of the topcoat-layer forming coating composition can be performed by, for example, spray coating, brush coating, or roller brush coating. Preferably, the amount of application of the topcoat-layer forming coating composition should be 0.03 g or more and 1.5 g or less as the amount of application per 100 cm2 after drying. When the amount of application of the topcoat-layer forming coating composition is less than 0.03 g, a sufficient water repellency may not be obtained. When the amount of application of the topcoat-layer forming coating composition exceeds 1.5 g, the water-repellent film may be easily peeled.

When the water-repellent coat is formed on the base material 9, the base material 9 can be applied to various components in products that are required to have water repellency. As products that are required to have water repellency, for example, the following are present: a heat exchanger in an outdoor unit of an air conditioning apparatus, an elevator, a refrigerator, a solar cell, and a radome. As the material of the base material 9, for example, the following are present: plastics, such as an unsaturated polyester, polyethylene, cross-linked polyethylene, polyvinyl chloride, polyimide, polypropylene, polystyrene, ABS resin, AS resin, fluororesin, and silicone resin; metals, such as aluminum and stainless steel; glass; and porcelain.

By virtue of the above structure, it is possible to provide a water-repellent coat whose water repellency is not easily deteriorated even when a surface of the coat is worn by friction, for example.

### Embodiment 2

FIG. 2 is a schematic sectional view of a water-repellent coat according to Embodiment 2. In the water-repellent coat according to Embodiment 2, the undercoat layer 6 has a two-layer structure including an undercoat lower layer 6b and an undercoat upper layer 6a; and the undercoat lower layer 6b has the spherical particles 2 and the base resin 1, and the undercoat upper layer 6a has the water-repellent particles 3 and the base resin 1. In this regard, the water-repellent coat according to Embodiment 2 is different from the water-repellent coat according to Embodiment 1. In the water-repellent coat of Embodiment 2, the undercoat lower layer 6b forms a layer which has the spherical particles 2 and the base resin 1 without having the water-repellent particles 3. Then, the base resin 1 that has the water-repellent particles 3, namely the undercoat upper layer 6a, is applied onto the undercoat lower layer 6b. The topcoat layer 5 that has the water-repellent particles 3 and the water-repellent resin 4 is applied onto the undercoat upper layer 6a in such a manner as to be in contact with the undercoat upper layer 6a. Therefore, the base resin 1 that does not have the water-repellent particles 3, that is, the undercoat lower layer 6b, is in contact with the surface of the base material 9, and the base resin 1 that has the water-repellent particles 3, that is, the undercoat upper layer 6a, is in contact with the topcoat layer 5.

The base resin 1 of the undercoat layer 6 has a role of strongly bonding the spherical particles 2 to the surface of the base material 9 to form a strong undercoat layer 6 having an irregular surface. In the water-repellent coat having the structure according to Embodiment 2, since the base resin 1 that does not have the water-repellent particles 3 is used in the undercoat lower layer 6b, the spherical particles 2 are fixed to the base material 9, thereby forming a strong irregular film, and thus improving the strength of the water-repellent coat. In addition, the base resin 1 that has the water-repellent particles 3 and serves as the undercoat upper layer 6a is applied onto the undercoat lower layer 6b, thereby giving affinity to the topcoat layer or the topcoat-layer forming coating composition. Since the undercoat upper layer 6a and the undercoat lower layer 6b are water-repellent coats containing the same resin, it is possible to improve the strength of the water-repellent coat, while maintaining the high adhesion of the undercoat layer 6 itself. In Embodiment 2, the spherical particles, the water-repellent particles, the base resin of the undercoat layer, the water-repellent resin of the topcoat layer, and the solvent for use in formation of the undercoat layer and the topcoat layer may be the same as those in Embodiment 1.

Preferably, the amount of the spherical particles 2 in the undercoat lower layer 6b should be 10 mass % or more and 500 mass % or less relative to the base resin 1, and more preferably should be 30 mass % or more and 200 mass % or less of the base resin 1. When the amount of the particles 2 is less than 10 mass % or more, the undercoat layer may not have sufficient irregularities. When the amount of the particles 2 exceeds 500 mass %, the undercoat layer may not have a sufficient strength for the undercoat layer.

Preferably, the amount of the water-repellent particles 3 in the undercoat upper layer 6a should be 10 mass % or more and 200 mass % or less relative to the base resin 1, and more preferably, should be 20 mass % or more and 100 mass % or less relative to the base resin 1. When the amount of the water-repellent particles 3 is less than 10 mass %, the adhesion between the undercoat layer and the topcoat layer may not be sufficiently improved. When the amount of the water-repellent particles 3 exceeds 200 mass %, the undercoat layer may not obtain a sufficient strength for the undercoat layer.

In Embodiment 2, the lower layer and the upper layer of the undercoat layer can both be formed by, for example, spray coating, brush coating, or roller brush coating, as described above. Preferably, the average thickness of the undercoat lower layer 6b should be 0.5 μm or more and 2000 μm or less. To be more specific, the average thickness of the undercoat lower layer 6b should be 1.0 μm or more and 500 μm or less. When the average thickness is less than 0.5 μm, the particles may be too sparse and the resistance to friction or other stimuli may not be sufficiently high. When the average thickness exceeds 2000 μm, the coat may have excessively large irregularities and thus have poor appearance or may have lower strength. Preferably, the average thickness of the undercoat upper layer 6a should be 0.05 μm or more and 10 μm or less. To be more specific, preferably, the average thickness should be 0.1 μm or more and 5 μm or less. When the average thickness is less than 0.05 μm, the undercoat layer has a smaller number of water-repellent particles on the surface and may not ensure affinity for the topcoat layer. When the average thickness exceeds 10 μm, the film irregularities formed by the lower layer may be too small. The thickness is calculated from the weight of the coat.

By virtue of the above structure, it is possible to provide a water-repellent coat whose strength is improved and whose water repellency is not easily deteriorated even when the surface of the coat is worn by friction, for example.

### Embodiment 3

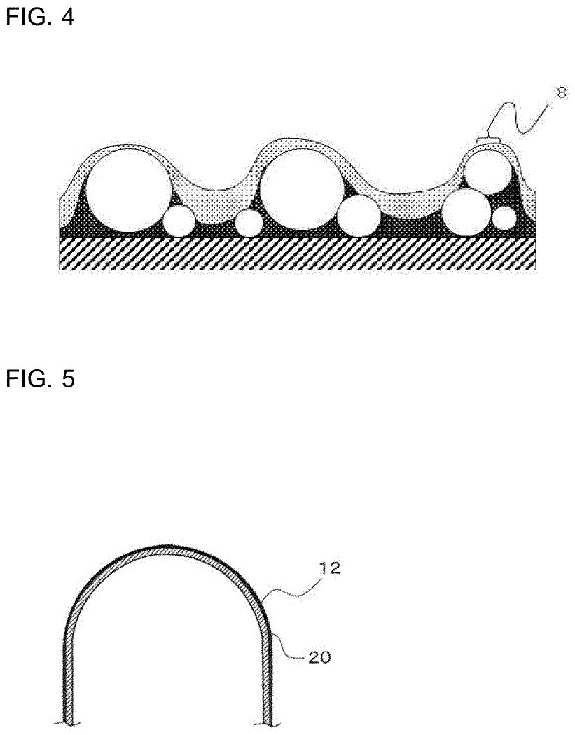

The water-repellent coats according to Embodiments 1 and 2 exhibit good water repellency such that water droplets roll away even when adhering to the water-repellent coats, and have high resistance to stimuli such as friction. Even if being repeatedly worn, the water-repellent coats can be effectively repaired by repairing deteriorated part thereof using a repair liquid. Specifically, the water repellency of the coats can be maintained for a long time using a repair liquid according to Embodiment 3. FIGS. 3 and 4 are schematic sectional views of a water-repellent coat according to Embodiment 3 before and after the water-repellent coat is worn. FIG. 3 is a schematic sectional view of the water-repellent coat which is deteriorated because of wear or other damages. FIG. 4 is a schematic sectional view of the water-repellent coat which is repaired using the repair liquid. As illustrated in FIG. 3, when wear is repeated and abrasion promotes, the water-repellent resin 4 and the base resin 1 are worn and as a result the spherical particles 2 are partially exposed (an area indicated by reference sign 7 in FIG. 3). As described above, fine water droplets tend to easily adhere in the vicinity of part of the particles 2 that is exposed, but water repellency is maintained. Even if the wear further promotes, the water repellency of the water-repellent coat can be recovered preferable by applying the repair liquid.

The repair liquid needs to be selected from repair liquids that dissolve the water-repellent resin, but do not dissolve the base resin, as well as the solvent for use in the topcoat-layer forming coating composition. That is, it suffices that a repair liquid having a boiling point and a viscosity suitable for the coating method is appropriately selected from such repair liquids as described above. As such resins, the following resins can be used: various fluorinated solvents; ether solvents, such as dimethyl ether and diethyl ether; and ketone solvents, such as acetone, methyl ethyl ketone, and methyl isobutyl ketone. Since these solvents have low polarity, the solvents easily dissolve the water-repellent resin, but do not easily dissolve the base resin. When being used as a repair agent, the solvents can be dried for a short time and many of the solvents have a mild smell. Fluorinated solvents has low flammability and is thus preferable in this regard. When being used as the repair liquid, pure solvents that do not have a water-repellent resin or water-repellent particles can also repair peeled part in the process of dissolution or drying.

The repair liquid can further contain a water-repellent resin and water-repellent particles having an average particle diameter of 5 nm or more and 30 nm or less, which are used in the topcoat layer. The ratio between the water-repellent particles and the water-repellent resin in the repair liquid is the same as that in Embodiment 1. Preferably, the total amount of the water-repellent particles and the water-repellent resin that are used in the repair liquid should be 10 mass % or less, and more preferably, should be 5 mass % or less relative to the repair liquid, although the ratio of the above total amount may be a ratio of the total amount to the topcoat-layer forming coating composition as described regarding Embodiment 1. When the total amount exceeds 10 mass %, the thickness of the water-repellent coat easily become nonuniform, and repairs are repeatedly made, as a result of which the film thickness is increased and the quality of the water-repellent coat itself is deteriorated. Thus, it is not preferable. If the water-repellent coat is deteriorated because friction, for example, the number of the components of the topcoat layer is decreased because of wear or other damages. The initial water-repellent coat can be reproduced by replenishing the topcoat layer using the repair liquid by the above decrease. An increase in film thickness is reduced by appropriately regulating the replenishment using the repair liquid. It is therefore possible to repeat the repair.

The deteriorated water-repellent coat is coated with the repair liquid, thereby recoating the peeled part of the topcoat layer. Because of this processing, the topcoat layer in the water-repellent coat is dissolved in the solvent of the repair liquid. Then, when the repair liquid dries, the topcoat layer is re-formed such that the components of the dissolved topcoat layer are combined with the components of the topcoat layer replenished by the repair liquid. The re-formed topcoat layer is in the same state as the topcoat layer that covers the entire undercoat layer before the topcoat layer has not yet been deteriorated.

The repair liquid is applied to the deteriorated water-repellent coat by, for example, spray coating, brush coating, or roller brush coating, and is then dried, whereby the water-repellent coat can be repaired. Before the repair liquid is applied, preferably, the water-repellent coat should be cleaned with a cleaning tool, such as a fabric, a non-woven fabric, a sponge, or a brush. This cleaning may be performed in the dry state, but preferably, cleaning should be performed with a cleaning tool soaked with water, because a hydrophilic substance adhering to the surface of the coat that will affect water repellency after repairing can be effectively removed with the cleaning tool.

In such a manner, since the deteriorated part of the water-repellent coat is repaired by the repair liquid, it is possible to recover the initial water repellency with a simple method, and provide a water-repellent coat whose water repellency is not easily deteriorated.

### Embodiment 4

The deterioration of water repellency of the film can be easily detected using water before the water-repellent coat is repaired using the repair liquid of Embodiment 3. Specifically, water is sprayed or poured on the water-repellent coat, or is applied to the water-repellent coat using a brush or sponge or other tools soaked with the water. Since the water adheres to part of the water-repellent coat that is deteriorated in water repellency, the deteriorated part (part where deterioration is detected in water-repellency) can be checked based on the state of the adhering water. By using colored water as the water, the visibility is improved and the repair of the coat is facilitated as described below. Preferably, the water should be colored with a water-soluble coloring matter. After the deteriorated part is detected, the color imparted by the coloring matter can be removed by washing with water or other methods, or using disappearance of color that results from deterioration of the coloring matter. Since the color that remains on the surface after applying this method is slight, even if common water-soluble color agents are applied, many of the common water-soluble color matters decompose under light or oxygen and naturally disappear. The deteriorated part can be detected using as the color agent, a fluorescent color agent that is transparent under visible light, without making the appearance poor.

### Embodiment 5

The water-repellent coat according to the present disclosure can prevent or reduce adherence of water droplets or dirt to outdoor equipment to which the water-repellent coat is applied. The water-repellent coat according to the present disclosure has high resistance to, for example, hail, snow hail, or rain, and can produce an effect for a long time.

FIG. 5 is a schematic sectional view of a radome having a water-repellent coat according to the present disclosure. Referring to FIG. 5, a water-repellent coat 12 according to the present disclosure is formed on an outer surface of a radome 20. In many cases, radomes are provided outdoors, and dirt sticks to the radomes and surfaces thereof deteriorate. Radars using microwaves or millimeter waves may have a problem in which water droplets adhere to outer surfaces of radomes. These problems can be avoided by using the water-repellent coat according to the present disclosure. The water-repellent coat 12 can obtain the advantages as described regarding Embodiments 1 and 2.

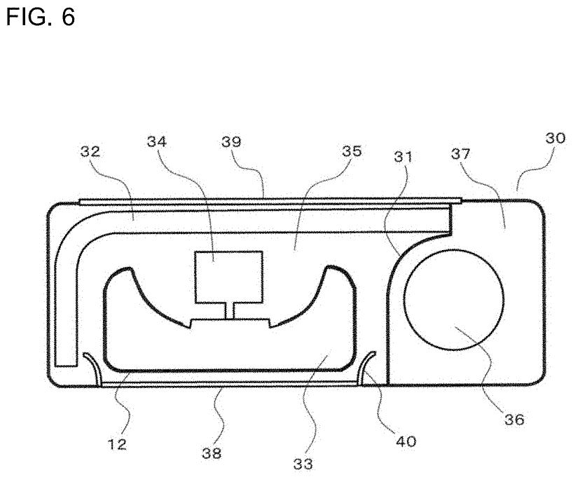

FIG. 6 is a schematic sectional view of an outdoor unit to which the water-repellent coat according to the present disclosure is applied. Referring to FIG. 6, the inside of an outdoor unit 30 is partitioned by a partition plate 31 into a heat exchange chamber 35 and a machine chamber 37. In the heat exchange chamber 35, a heat exchanger 32, a fan 33, and a fan motor 34 are provided; and in the machine chamber 37, a compressor 36 is provided. The heat exchange chamber 35 has an air outlet 38 and an air inlet 39. At the air outlet 38, a bell mouth 40 is provided. The water-repellent coat 12 according to the present disclosure is formed on a surface of the fan 33. For example, snow may adhere to the fan during a heating operation and may reduce the efficiency or hinder continuous operation. However, because of formation of the water-repellent coat according to the present disclosure on the surface of the fan 33, it is possible to prevent or reduce adhesion of snow or ice to alleviate the above problems. In addition, by forming the water-repellent coat according to the present disclosure on a surface of the heat exchanger 32, it is also possible to prevent or reduce adhesion of snow or ice. When snow or ice adheres to or is separated from the surface of the fan or the surface of the heat exchanger, great frictional forces act on the surface. Because of formation of the water-repellent coat according to the present disclosure, the water-repellent coat can produce effects for a long time. The water-repellent coat 12 can obtain the advantages as described regarding Embodiments 1 and 2.

Regarding the present disclosure, the following are concrete descriptions that ae made by comparing Examples and Comparative Examples, but the descriptions are not liming.

### Example 1

Spherical molten silica particles having an average particle diameter of 10.2 μm (made by Denka Company Limited) were used as spherical particles, hydrophobic particles fumed silica (RX300, made by Nippon Aerosil Co., Ltd., and average particle diameter 7 nm) was used as water-repellent particles, and a fluororesin (Lumiflon LF200F, AGC Inc.) was used as a base resin. An undercoat layer-forming coating composition having the spherical molten silica particles having 10 mass % of the fluororesin and 20 mass % of the water-repellent particles relative to the fluororesin was prepared. The undercoat layer-forming coating composition was applied to an upper surface of an ABS resin plate with a brush and dried at 120 degrees C. for 15 minutes to form an undercoat layer. The average thickness of undercoat layers formed in the above manner was measured under a microscope and found to be 8 μm.

Next, a topcoat-layer forming coating composition having 10 mass % of water-repellent particles and 20 mass % of water-repellent resin relative to the entire composition was prepared by using hydrophobic fumed silica (RX300, made by Nippon Aerosil Co., Ltd., having average particle diameter 7 nm) as the water-repellent particles, a fluororesin (Novec 1710, made by 3M Japan Limited) as the water-repellent resin, and a fluorinated solvent (Novec 7200, made by 3M Japan Limited) as a solvent. The topcoat-layer forming coating composition was applied to the upper surface of the undercoat layer by spray coating and then dried at 120 degrees C. for 5 minutes to form a topcoat layer. The application of the topcoat-layer forming coating composition was performed such that the amount of the fluororesin after drying per 100 cm2 was approximately 0.1 g.

Thereafter, a fluorinated solvent (Novec 7200, made by 3M Japan Limited) not having water-repellent particles or water-repellent resin was used as a repair liquid.

The initial water repellency was evaluated by dropping approximately 5 μL of water droplets from a tip of a needle having an inner diameter of 0.1 mm and coated with PTFE (polytetrafluoroethylene) to the surface of the water-repellent coat, and measuring a contact angle thereof with a contact angle meter (CX-150 model made by Kyowa Interface Science Co., LTD). The water repellency after wear was evaluated by measuring the contact angle of water after moving a polyester non-woven fabric back and forth 10 times while pushing the polyester non-woven fabric against the surface of the water-repellent coat under a load of 80 g/cm2 using a crockmeter (Yasuda Seiki Seisakusho, LTD). The evaluation results of water repellency are indicated in Table 1. Regarding Table 1, the contact angle was measured at points of time when the number of friction deterioration and repetitions of application of the repair liquid is 0 (at beginning), 3, and 6. Water repellency was determined based on the contact angle of water.

### Example 2

A repair liquid having 0.1 mass % of the water-repellent particles and 0.2 mass % of the water-repellent resin relative to the entire repair liquid was used for a water-repellent coat including the same topcoat layer and the same undercoat layer as in Example 1. The evaluation results of water repellency are indicated in Table 1.

### Example 3

A water-repellent coat was formed in the same manner as in Example 1 by using the same undercoat layer as in Example 1 and setting the amount of the water-repellent particles in the topcoat layer relative to the entire coating composition to 20%. A repair liquid having 0.2 mass % of the water-repellent particles and 0.2 mass % of the water-repellent resin relative to the entire repair liquid was used for the coat. The evaluation results of water repellency are indicated in Table 1.

### Comparative Example 1

A water-repellent coat was formed in the same manner as in Example 1 except that in Comparative Example 1, an undercoat layer having an average thickness of 8 μm was formed by using an undercoat layer coating composition not having water-repellent particles. A repair liquid having 0.1 mass % of water-repellent particles and 0.2 mass % of water-repellent resin relative to the entire repair liquid was used for the coat. The evaluation results of water repellency are indicated in Table 1.

### Comparative Example 2

A water-repellent coat was formed in the same manner as in Example 1 except that in Comparative Example 2, an undercoat layer having an average thickness of 8 μm was formed by using an undercoat layer coating composition not having water-repellent particles and setting the mixing ratio of the water-repellent particles to the entire topcoat layer coating composition to 20%. A repair liquid containing 0.2 mass % of water-repellent particles and 0.2 mass % of water-repellent resin relative to the entire repair liquid was used for the coat. The evaluation results of water repellency are indicated in Table 1.

### Comparative Example 3

A water-repellent coat was formed by preparing, for a topcoat layer, a topcoat-layer forming coating composition having 10 mass % of water-repellent particles and 5 mass % of the water-repellent resin relative to the entire composition. Comparative Example 3 was the same as Example 1 except that in Comparative Example 3, a repair liquid having 10 mass % of water-repellent particles and 5 mass % of water-repellent resin relative to the entire repair liquid was used. In Comparative Example 3, the repair liquid was a high concentration of repair liquid and thus applied by spray coating, not brush coating that easily results in uneven coating. The evaluation results of water repellency are indicated in Table 1.

### Comparative Example 4

Comparative Example 4 was the same as Example 1 except that in Comparative Example 4, a topcoat layer was formed on an ABS resin plate without using an undercoat layer to form a water-repellent coat, and a repair liquid having 0.2 mass % of water-repellent particles and 0.2 mass % of water-repellent resin relative to the entire repair liquid was used for the water-repellent coat. The evaluation results of water repellency are indicated in Table 1.

As can be seen from Table 1, the water-repellent coat of Example 1 has high water repellency with a contact angle of more than 150° at the beginning, and maintains high water-repellency with a contact angle of more than 140° after wear, and the water-repellent coat thus has wear resistance. In Example 1, it can be seen that the water-repellent coat is repeatedly repaired by using a solvent not having water-repellent resin or water-repellent particles as a repair liquid, as a result of which the water repellency slightly deteriorates, but satisfactory recovery property is obtained. In Examples 2 and 3, high water repellency with a contact angle of more than 150° is obtained both after application of the topcoat layer and after application of the repair liquid, and high water repellency with a contact angle of more than 140° is maintained after rubbing. The water repellency is not lowered even after repair is repeated. In Example 1, the thickness of the topcoat layer gradually decreases because only the solvent is used as a repair liquid. In Examples 2 and 3, the thickness of the topcoat layer does not decrease because a dilute solution is used as a repair liquid.

In Comparative Examples 1 and 2, water repellency is obtained at the beginning, but is greatly deteriorated by friction. Furthermore, when repair is repeated, the water repellency is recovered but gradually deteriorates, and a wear resistance is not obtained. This is because since the undercoat layer does not have water-repellent particles, the topcoat layer is easily peeled, and a topcoat layer is not easily satisfactorily formed even by repair. In Comparative Example 3, high water repellency is obtained after application of the repair liquid and after repair. However, water repellency is greatly impaired by wear, and wear resistance is low, particularly after repair. In the case of using a high concentration of maintenance liquid, it can be seen that apparent water repellency is recovered, but adhesion between the topcoat layer and the undercoat layer is not achieved, and the deteriorated topcoat layer cannot be repaired. In Comparative Example 4, wear resistance is not obtained because of the absence of an undercoat layer. Therefore, it can also be seen that wear resistance of super water repellency can be obtained because of provision of an undercoat layer.

TABLE 1

| | | | | | Contact Angle Before and After Rubbing | | | |
|---|---|---|---|---|---|---|---|---|
| | | | | | (upper cell: before rubbing, lower cell: | | | |
| | Undercoat Layer- | | | | after rubbing) | | | |
| | Forming Coating | | | | | after 3 | after 6 | |
| | Liquid | | Repair Liquid | | | times of | times of | |
| | water- | water- | water- | water- | | application | application | |
| | repellent | repellent | repellent | repellent | | of repair | of repair | |
| | particles | resin | particles | resin | at beginning | liquid | liquid | Note |
| Example 1 | 10% | 20% | 0% | 0% | 153° | 150° | 145° | repair liquid |
| | | | | | 142° | 140° | 140° | having only |
| Example 2 | 10% | 20% | 0.1% | 0.2% | 152° | 152° | 155° | solvent |
| | | | | | 140° | 141° | 143° | |
| Example 3 | 20% | 20% | 0.2% | 0.2% | 155° | 157° | 156° | |
| | | | | | 146° | 143° | 147° | |
| Comparative | 10% | 20% | 0.1% | 0.2% | 152° | 145° | 130° | no water-repellent |
| Example 1 | | | | | 100° | 95° | 85° | particles in |
| | | | | | | | | undercoat layer |
| Comparative | 20% | 20% | 0.2% | 0.2% | 156° | 147° | 145° | no water-repellent |
| Example 2 | | | | | 115° | 98° | 94° | particles in |
| | | | | | | | | undercoat layer |
| Comparative | 10% | 5% | 10% | 5% | 153° | 155° | 152° | high concentration |
| Example 3 | | | | | 129° | 70° | 61° | of repair liquid |
| Comparative | 20% | 20% | 0.2% | 0.2% | 149° | 150° | 149° | no undercoat |
| Example 4 | | | | | 60° | 67° | 69° | layer |

### Example 4

A coating liquid for the undercoat layer was prepared to have a composition given by adding to a fluororesin (Lumiflon 200, made by AGC Inc.) serving as a base resin, 20 mass % (relative to the resin content) of spherical silicone particles having an average particle diameter of 6 μm (Tospeari 20001B, made by Momentive Japan) serving as spherical particles, relative to the fluororesin, 10 mass % of hydrophobic fumed silica (RX300, made by Nippon Aerosil Co., Ltd., and having average particle diameter 7 nm) serving as water-repellent particles, relative to the fluororesin, such that non-volatile content (the total amount of the spherical particles, the water-repellent resin, and the base resin) is 20 mass % relative to the total mass of the coating liquid. The coating liquid for the undercoat layer was applied to an upper surface of a PP plate by brush coating to form an undercoat layer. The average thickness of undercoat layers formed in the above manner was 8.8 μm. A repair liquid in an aerosol can was prepared by mixing with a fluororesin (INT 332QC, made by Noda Screen Co., Ltd.) serving as a water-repellent resin, 50 mass % of hydrophobic fumed silica (RX300, made by Nippon Aerosil Co., Ltd.) serving as water-repellent particles, relative to the fluororesin, to form an 1-mass %-dispersion liquid in a mixed solvent of a fluorinated solvent and dimethyl ether at a weight ratio of 1:5. The same liquid as this repair liquid was applied by spray coating such that a coating amount per 100 cm2 is 0.5 g in non-volatile content, to form a topcoat layer. The repair liquid was applied by spray coating such that a coating amount per 100 cm2 is approximately 0.1 g in fluororesin after drying. Changes in water repellency of the water-repellent coat in the case of using the repair liquid were evaluated in the same manner as in Example 1. The adhesion was also evaluated with a paint film bending tester (Yasuda Seiki Seisakusho, LTD). The adhesion was compared based on the maximum mandrel diameter at which the undercoat layer was peeled. These results are summarized in Table 2.

### Example 5

A coating liquid for an undercoat lower layer was prepared to have a composition given by adding, to a fluororesin (Lumiflon 200, made by AGC Inc.) serving as a base resin, 20 mass % of spherical silicone particles having an average particle diameter of 6 μm (Tospeari 2000B, available from Momentive Japan) serving as particles, relative to the fluororesin, to form a xylene dispersion having 20 mass % of non-volatile content. A coating liquid for an undercoat upper layer was prepared to have a composition given by adding, to a fluororesin (Lumiflon 200, made by AGC Inc.) serving as a base resin, relative to the fluororesin, 10 mass % of hydrophobic fumed silica (RX300, made by Nippon Aerosil Co., Ltd., and having average particle diameter 7 nm) serving as water-repellent particles, relative to the fluororesin, to form a xylene dispersion having 20 mass % of non-volatile content. The undercoat lower layer and the undercoat upper layer were formed on an upper surface of a PP plate by spray coating to form an undercoat layer. The average thickness of lower layers was 8 μm, and the average thickness of topcoatings was 1.2 μm. The application of the topcoat layer and the application of a maintenance agent were performed in the same manner as in Example 4.

### Comparative Example 5

A film not having water-repellent particles was formed as an undercoat layer of Example 5. In other words, an undercoat having no upper layer was formed. The average thickness of lower layers was 7.2 μm, and the average thickness of topcoatings was 1.2 μm. Application of a topcoat layer and application of a maintenance agent were performed in the same manner as in Example 4.

TABLE 2

| | | Contact Angle Before and After Rubbing | | | |
|---|---|---|---|---|---|
| | Adhesion | (upper cell: before rubbing, | | | |
| | mandrel | lower cell: after rubbing) | | | |
| | diameter | | after repair | after repair | |
| | at which | | liquid is | liquid is | |
| | peeling | | applied | applied | |
| | occurs | at beginning | 3 times | 6 times | Note |
| Example 4 | 12 mm | 153° | 150° | 149° | |
| | | 130° | 132° | 132° | |
| Example 5 | 6 mm | 152° | 149° | 154° | undercoat layer |
| | | 134° | 134° | 144° | including two layers |
| Comparative | 6 mm | 153° | 157° | 149° | no water-repellent |
| Example 5 | | 62° | 69° | 71° | particles in |
| | | | | | undercoat layer |

As can be seen from Table 2, in Examples 4 and 5 and Comparative Example 5, peeling occurs with thin mandrels, and high adhesion is obtained. As Examples 4 and 5 are compared, in Example 5, the adhesion is higher. In Example 5, since a layer not having water-repellent particles is present as a lower layer of the undercoat layer, the adhesion is improved. In Comparative Example 5, the undercoat layer exhibits high adhesion, and super water repellency is obtained after repairing, but water repellency is greatly deteriorated by friction. This is because the adhesion of the topcoat layer is low since the undercoat layer does not have the water-repellent particles.

### Examples 6 and 7

A coating liquid for an undercoat upper layer was prepared by using molten silica having an average particle diameter of 10.2 μm (made by Denka Company Limited) as spherical particles, hydrophobic fumed silica (RX300, made by Nippon Aerosil Co., Ltd., and having average particle diameter 7 nm) as water-repellent particles, and a polyurethane resin (Bumock 16-416, made by DIC Corporation) as a base resin to form an MEK dispersion having 20 mass % of non-volatile content at the mixing ratio indicated in Table 3. The coating liquid for an undercoat upper layer was applied to an upper surface of a PP plate by brush coating to form an undercoat layer. The average thickness of undercoat layers formed in such a manner was 8.6 μm. A coating liquid for a topcoat layer was prepared by using hydrophobic fumed silica (RX300, made by Nippon Aerosil Co., Ltd.) as water-repellent particles, a fluororesin (Novec 1710, made by 3M Japan Limited) as a water-repellent resin, and a fluorinated solvent (Novec 7200, made by 3M Japan Limited) as a solvent. Table 2 indicates the concentrations of the coating liquid and the repair liquid. The topcoat layer was formed by spray coating such that a coating amount per 100 cm2 was approximately 0.5 g in non-volatile content. The repair liquid was applied by brush coating such that a coating amount per 100 cm2 is approximately 0.1 g in non-volatile content.

### Examples 8 and 9

Examples 8 and 9 were the same as Example 6 except that in Examples 8 and 9, a coating liquid for an undercoat layer was prepared by using hydrophobic fumed silica (RX200, made by Nippon Aerosil Co., Ltd., and having average particle diameter 12 nm) as water-repellent particles to form an MEK dispersion liquid having 20 mass % of non-volatile content with the composition indicated in Table 3. The water-repellent coat was evaluated in the same manner as in Example 6.

### Comparative Examples 6 and 7

Comparative Examples 6 and 7 were the same as Example 6 except that in Comparative Examples 6 and 7, a coating liquid for an undercoat layer was prepared by using hydrophobic fumed silica (RX50, made by Nippon Aerosil Co., Ltd., having average particle diameter 40 nm) as water-repellent particles to form an MEK dispersion liquid having 20 mass % of non-volatile content with the composition indicated in Table 3. The same evaluation as in Example 6 was performed.

TABLE 3

| | | | Contact Angle Before and After Rubbing | | | Note |
|---|---|---|---|---|---|---|
| | Undercoat Layer- | | (upper cell: before rubbing, | | | diameter |
| | Forming Coating | | lower cell: after rubbing) | | | of water- |
| | Liquid | | | after repair | after repair | repellent |
| | water- | water- | | liquid is | liquid is | particles |
| | repellent | repellent | | applied | applied | in undercoat |
| | particles | resin | at beginning | 3 times | 6 times | layer |
| Example 6 | 15% | 5% | 148° | 152° | 149° | 7 nm |
| | | | 139° | 140° | 142° | |
| Example 7 | 10% | 10% | 152° | 155° | 155° | 7 nm |
| | | | 145° | 144° | 145° | |
| Example 8 | 15% | 5% | 155° | 154° | 151° | 14 nm |
| | | | 135° | 135° | 132° | |
| Example 9 | 15% | 10% | 155° | 152° | 151° | 14 nm |
| | | | 137° | 136° | 137° | |
| Comparative | 15% | 10% | 156° | 151° | 155° | 40 nm |
| Example 6 | | | 90° | 60° | 52° | |
| Comparative | 10% | 20% | 151° | 155° | 153° | 40 nm |
| Example 7 | | | 92° | 98° | 56° | |

In Examples 6 to 9, high water repellency and high friction resistance are obtained. Water repellency can be recovered even after repair is repeatedly made, and wear resistance does not deteriorate. In Comparative Examples 6 and 7, the wear resistance of water repellency is not obtained, though the compositions are the same as those in Examples 6 to 9. This is because the particle diameter of the water-repellent particles is too large to obtain a sufficient adhesion of the topcoat layer.

### Example 10

The water-repellent coat of Example 1 was formed on a surface of a resin dome having a diameter of approximately 30 cm. The water-repellent coat prevented or reduced adhesion of water droplets even in the rain. When a 0.05% aqueous solution of Blue No. that is a water-soluble coloring matter was sprayed with an atomizer one year after outdoor exposure, fine blue water droplets adhered. Many water droplets adhered near the top of the dome, and adhesion of water droplets was also distributed linearly on a side surface of the dome. From this, it was found that water repellency was partially deteriorated by snow or something that rubs the water-repellent coat. The water repellency of the entire resin dome was recovered by, after drying colored water, spraying the repair liquid of Example 1 onto only the colored part. Color disappeared after several days because of decomposition of the color matter under light or oxygen. According to this method, it was confirmed that an object can be rendered water-repellent, and even if water repellency is impaired by wear or other damages, the initial water repellency of only worn part can be recovered by a simple process without applying the repair liquid to the entire surface.

### Example 11

The water-repellent coat of Example 6 was formed on a fan of an outdoor unit in a room air conditioner. Because of this formation of the water-repellent coat, during snowfall, snow hardly adheres to the fan in operation of the outdoor unit. When colored water in Example 10 was sprayed on the fan after the outdoor unit is operated for approximately 3 months, fine water droplets easily adhere to ends of the fan, and wear promoted. The repellency against fine water droplets was recovered by spraying the repair liquid onto the above part. In the case where an object has a complicated shape like the fan, it is hard to check water repellency of the object, it takes a lot of trouble to apply the repair liquid to the entire surface of the object, and the amount of the repair liquid to be applied is also increased. On the other hand, in the method according to the present disclosure, an object can be rendered water-repellent, and even if water repellency of the object is impaired by wear or other damages, the initial water repellency of only part of the object that is determined to be worn by checking can be recovered by a simple way without applying the repair liquid to the entire surface.

### REFERENCE SIGNS LIST

1: base resin, 2: spherical particles, 3: water-repellent particles, 4: water-repellent resin, 5: topcoat layer, 6: undercoat layer, 6a: undercoat upper layer, 6b: undercoat lower layer, 7: deteriorated part of topcoat layer, 8: recovered part of topcoat layer, 9: base material, 12: water-repellent coat, 20: radome, 30: outdoor unit, 31: partition plate, 32: heat exchanger, 33: fan, 34: fan motor, 35: heat exchange chamber, 36: compressor, 37: machine chamber, 38: air outlet, 39: air inlet, 40: bell mouth

1. A water-repellent coat comprising:
an undercoat layer formed on a surface of a base material and containing a base resin, at least one kind of spherical particles, and water-repellent particles, the at least one kind of spherical particles having an average particle diameter of 2 μm or more and 1000 μm or less and being selected from the group consisting of spherical molten silica particles, spherical molten alumina particles, and spherical silicone resin particles, the water-repellent particles having an average particle diameter of 5 nm or more and 30 nm or less; and
a topcoat layer formed on the undercoat layer and containing a water-repellent resin and the water-repellent particles contained in the undercoat layer.

2. The water-repellent coat of claim 1, wherein the undercoat layer includes
an undercoat lower layer containing the spherical particles and the base resin, and
an undercoat upper layer containing the water-repellent particles and the base resin.

3. The water-repellent coat of claim 1, wherein the base resin is a polyurethane resin, a fluororesin, or a silicone resin.

4. The water-repellent coat of claim 1, wherein the water-repellent resin is a fluororesin or a silicone resin.

5. The water-repellent coat of claim 1, wherein the water-repellent particles are hydrophobized inorganic particulates.

6. A product wherein the water-repellent coat of claim 1 is formed on a surface of a base material.

7. A water-repellent coat repairing method comprising repairing deteriorated part of the water-repellent coat of claim 1 by applying to the water-repellent coat, a repair liquid containing a solvent that dissolves the water-repellent resin but does not dissolve the base resin.

8. The water-repellent coat repairing method of claim 7, wherein the solvent is a fluorinated solvent, an ether solvent, or a ketone solvent.

9. The water-repellent coat repairing method of claim 7, wherein the repair liquid further contains the water-repellent particles and the water-repellent resin.

10. The water-repellent coat repairing method of claim 7, wherein a total amount of the water-repellent particles and the water-repellent resin is 10 mass % or less relative to the entire repair liquid.

11-12. (canceled)

13. The water-repellent coat repairing method of claim 7, wherein after deteriorated part of the water-repellent coat is detected based on a state of water or colored water that adherers to the water-repellent coat, the repair liquid is applied to the detected deteriorated part of the water repellent coat, thereby repairing the detected deteriorated part of the water repellent.
